(19) United States
(12) Patent Application Publication
(10) Pub. No.: US 2005/0230220 A1
(43) Pub. Date: Oct. 20, 2005

(54) Container storage and delivery system

(76) Inventors: Frederick J. Stingel III, Asheville, NC (US); Jeffrey W. Stingel, Asheville, NC (US)

Correspondence Address: AKERMAN SENTERFITT, P.O. BOX 3188, WEST PALM BEACH, FL, 33402-3188, US

(21) Appl. No.: 11/081,995

(22) Filed: Mar. 16, 2005

Related U.S. Application Data
(63) Continuation-in-part of application No. 10/389,513, filed on Mar. 14, 2003.

(51) Int. Cl. B65G 1/00

(52) U.S. Cl. 198/348; 414/268

(57) ABSTRACT

A container directing apparatus for directing containers carried by a conveyor, includes a lifting device for lifting the containers off of the conveyor. A moving apparatus moves the container off of the lifting device. The lifting device can include a lifting surface which can be inclined upward in the direction of container travel, such that containers move up onto the lifting surface. The lifting surface can then be leveled prior to moving the containers off of the lifting device. A container storage and delivery system and a method for storing and delivering containers are also disclosed.

### CROSS REFERENCE TO RELATED APPLICATIONS

This is application is a continuation-in-part of U.S. patent application Ser. No. 10/389,513, filed Mar. 14, 2003.

### FIELD OF THE INVENTION

This invention relates generally to container storage and delivery systems.

### BACKGROUND OF THE INVENTION

Container storage and delivery systems typically include a supply conveyor for conveying the containers to one or more storage stations or devices. There exist individual container storage and delivery systems in which items are stored vertically and selectively dispensed at the bottom onto a conveyor system. Typically items are passed along a conveyor system throughout a warehouse or other appropriate facility, and the items are removed from the conveyor by personnel at appropriate locations along the conveyor. A conventional conveyor is a chain-type conveyor which comprises a single chain covered by a plurality of top plates that are secured to the chain. Containers are moved by placing the container onto the top plates of this conveyor system. Traditional chain conveyors are not suitable for some of the uses of belt conveyors.

### SUMMARY OF THE INVENTION

This invention is directed to a container directing apparatus for directing two or more containers together along a conveyor. The containers may be carried by a conveyor that includes a lifting device for lifting the containers off of the conveyor. A moving apparatus may move the containers off of the lifting device. The containers can be directed to one or more storage stations.

The conveyor moves the containers in a direction of travel and the lifting device may include a lifting surface. The lifting device inclines the lifting surface upward in the direction of container travel such that containers being moved by the conveyor are lifted upward onto the lifting surface. The lifting device, after a container has been moved onto the inclined lifting surface, substantially levels the lifting surface. The moving apparatus then moves the container off of the lifting surface, where it can be directed into a suitable structure such as a storage station. In at least one embodiment, the moving apparatus may be configured to move two or more containers together from the lifting surface. The lifting device can include a stop for stopping the movement of the container on the lifting surface. The stop can be operatively connected to the lifting surface, whereby lifting of the stop will incline the lifting surface.

The lifting device can include any suitable structure for inclining and leveling the lifting surface. This structure can include one or more solenoids. Control apparatus can be provided to control the operation of the lifting device and the moving apparatus. The control apparatus can be a computer system that tracks and directs containers through the container storage and delivery system. The conveyor can include first and second substantially parallel conveyor tracks, and the lifting surface can be provided between the tracks. The conveyor can be a chain conveyor.

The moving apparatus can comprise a push member such as a push plate and structure for moving the push plate. The push plate may be configured to push two or more containers together. The structure for moving the push plate can be any suitable structure such as one or more solenoids, or pneumatic operating structure. The push plate may be moved over the lifting device, such that the push plate contacts the containers and moves the containers off of the lifting surface. The container directing apparatus may also include at least one container storage station for storing the containers and supplying the conveyor with containers.

A method of conveying articles includes the step of conveying at least two containers on a conveyor. A lifting device lifts the containers off of the conveyor. A moving apparatus moves the containers off of the lifting device and into suitable structure such as a storage station. The storage station can be a vertically accumulating storage and delivery apparatus.

The method can include the step of providing a lifting surface on the lifting device, and inclining the lifting surface upward in the direction of travel of the container, such that containers traveling on the conveyor will be carried upward on the lifting surface. A stop can be used for stopping the movement of containers on the lifting surface.

### BRIEF DESCRIPTION OF THE DRAWINGS

There are shown in the drawings embodiments which are presently preferred, it being understood, however, that the invention is not limited to the precise arrangements and instrumentalities shown, wherein:

FIG. 1 is a side elevation view of a container directing apparatus according to the invention, in a first mode of operation.

FIG. 2 is a side elevation view of a container directing apparatus according to the invention, in a second mode of operation.

FIG. 3 is a side elevation view of a container directing apparatus according to the invention, in a third mode of operation.

FIG. 4 is a side elevation view of a container directing apparatus according to the invention, in a fourth mode of operation.

FIG. 5 is a perspective view of a container storage and delivery system according to the invention, in a first mode of operation.

FIG. 6 is a perspective view of a container storage and delivery system according to the invention, in a second mode of operation.

FIG. 7 is a perspective view of a container storage and delivery system according to the invention, in a third mode of operation.

FIG. 8 is a perspective view of a container storage and delivery system according to the invention, in a fourth mode of operation.

FIG. 9 is a perspective view of a container storage and delivery system according to the invention, in a fifth mode of operation.

FIG. 10 is a perspective view of a container storage and delivery system according to the invention, in a sixth mode of operation.

FIG. 11 is a perspective view of a plurality of container storage and delivery systems according to the invention in a storage facility.

FIG. 12 is a perspective view, partially in phantom, of a moving apparatus according to the invention.

FIGS. 13A-D are side elevations illustrating the sequential operation of a chain conveyor system according to the invention.

FIG. 14 is a perspective view of a chain conveyor suitable for use with the invention.

FIG. 15 is a side elevation of an alternative embodiment of the subject invention.

### DETAILED DESCRIPTION OF THE INVENTION

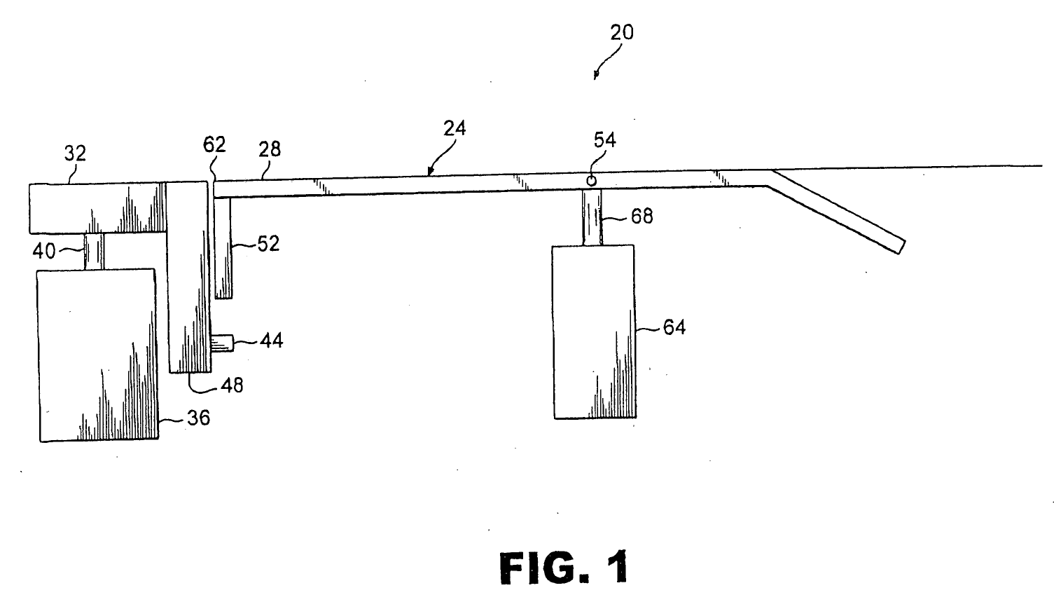

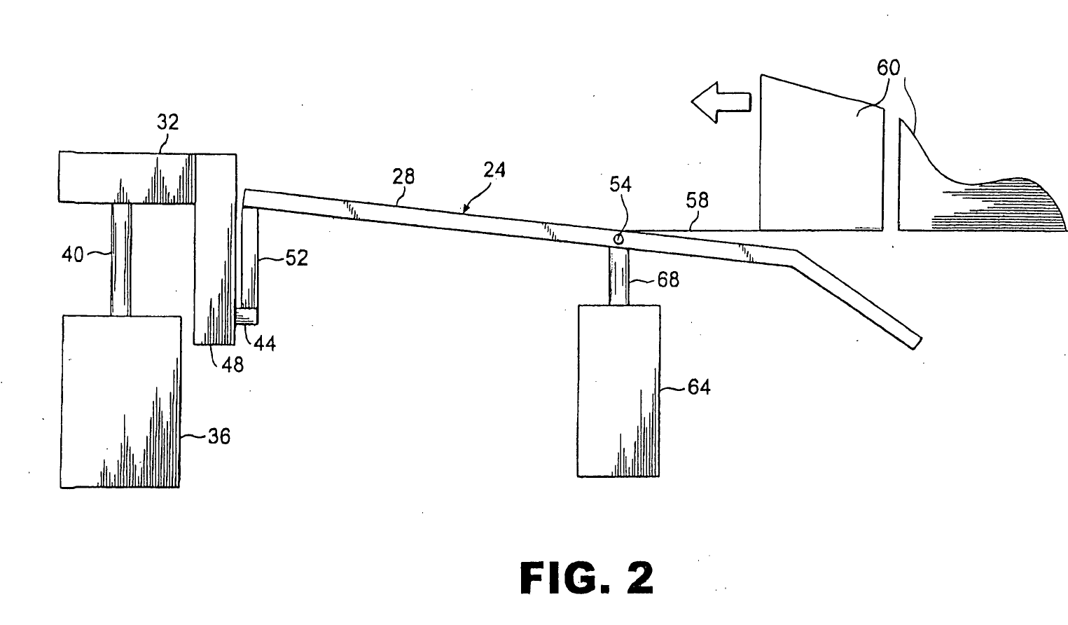

FIGS. 1-14 disclose a container directing apparatus 20 for directing a plurality of containers along a container movement system. The container directing apparatus may be configured to move a plurality of containers and to offload two or more containers together. Handling two or more containers together can increase the efficiency of the apparatus 20. The container directing apparatus 20, as shown in FIG. 1, includes a lifting device 24 with a lifting surface 28. A stop 32 can be provided for stopping the movement of containers. The lifting surface 28 and stop 32 are shown in the lowered position in FIG. 1. Suitable structure is provided for lifting the stop 32 upon demand. The structure can be a solenoid 36 as shown. Operation of the solenoid 36 raises shaft 40 to raise stop 32 (FIG. 2).

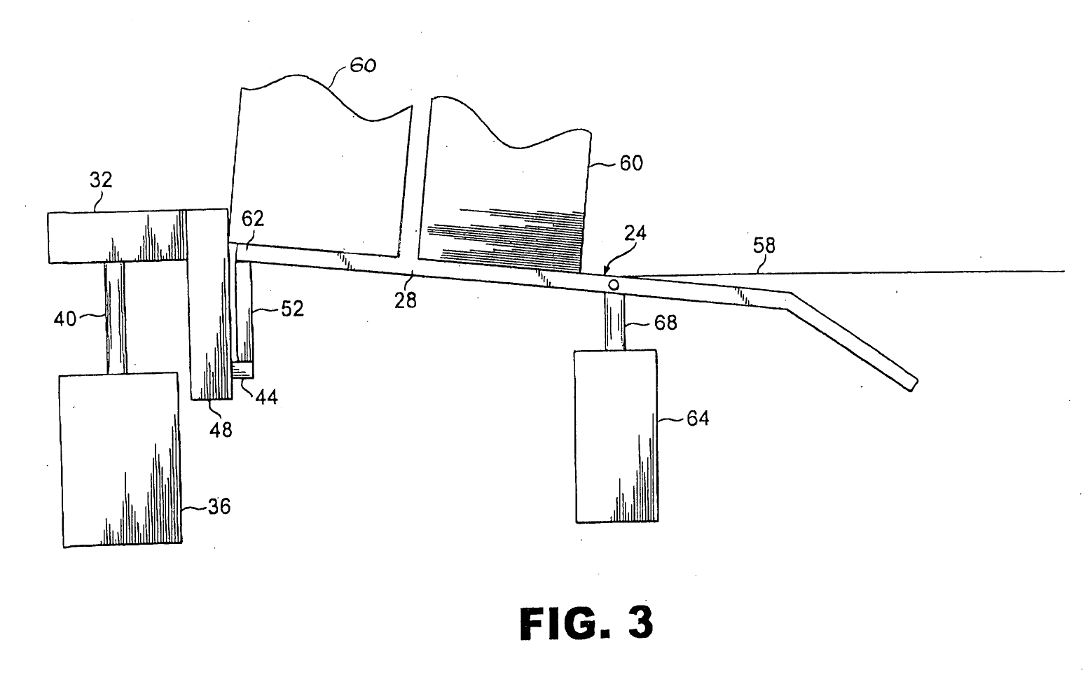

Structure is also provided for inclining the lifting surface 28 in the direction of container travel. This structure can be any suitable structure. In the embodiment shown, a projection 44 is provided on a depending flange 48 of the stop 32, such that the projection 44 is raised with the stop 32. As it is raised, the projection 44 contacts depending flange 52 connected to lifting surface 28 such that raising of the stop 32 will cause the inclining of the lifting surface 28 as shown in FIG. 2. The lifting surface 28 is pivotally mounted at pivot point 54 to permit such pivotal inclining. Other constructions are possible to permit such movement. Two or more containers 60 moving along conveyor surface 58 will contact the inclined lifting surface 28 (FIG. 3) and will move up the inclined lifting surface 28. The presence of the stop 32 will prevent the containers 60 from moving over the forward edge 62 of the lifting surface 28.

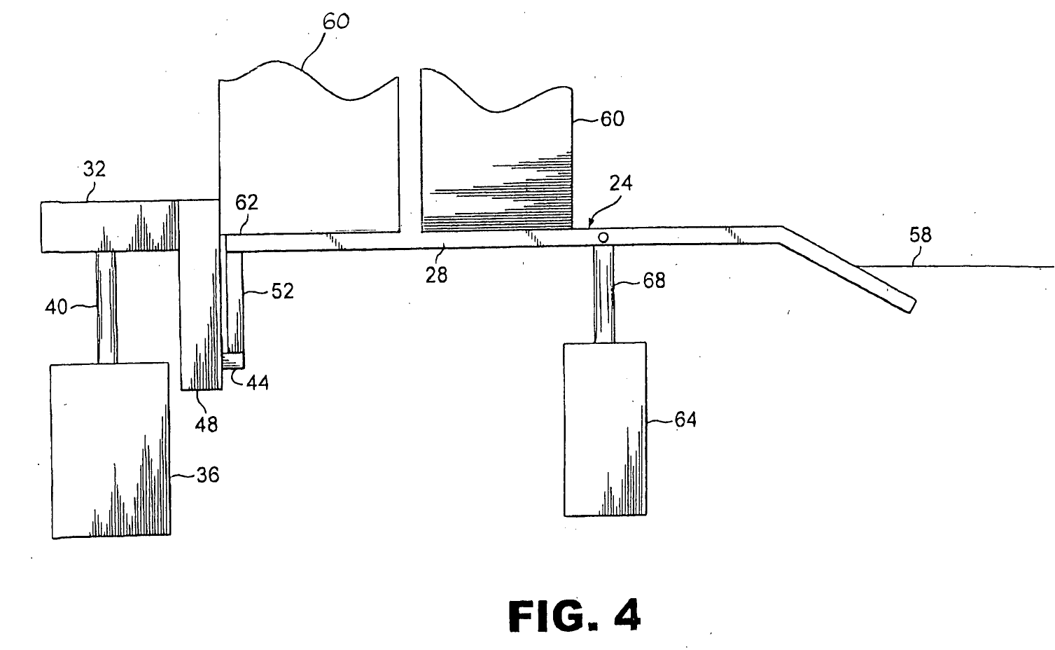

The lifting surface 28 is then preferably substantially leveled. It is not necessary that the lifting surface 28 be perfectly level, however, it is preferable for efficient transfer of the container off of the lifting surface 28. The structure used to level the lifting surface 28 can be any suitable structure. In the embodiment shown, a solenoid 64 is operated to manipulate a shaft 68 which is connected to the lifting surface 28 so as to lift a rearward portion of the lifting surface 28 to a level commensurate with the height of the forward edge 62 of the lifting surface 28, as shown in FIG. 4. The two or more containers 60 are then ready to be pushed off of the lifting surface 28.

The solenoid 36 and solenoid 64 can be of any suitable design. Lifting structures other than an electric solenoid, such as pneumatic and hydraulic lifting apparatus, can also be used.

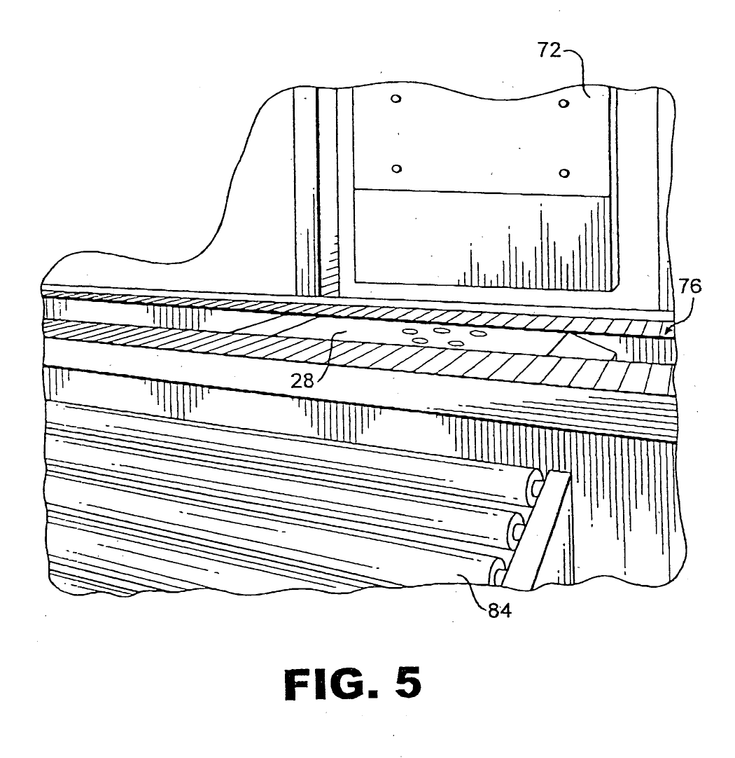

There is shown in FIG. 5 a moving apparatus according to the invention. The moving apparatus can be any suitable structure adapted to move the containers 60 off of the lifting surface 28. In the embodiment shown, the moving apparatus has a push plate 72 that is moved across the lifting surface 28 to move the container off of conveyor 76. The push plate 72 is sized to contact and move two or more containers 60 together. Alternatively, the moving apparatus could be designed to pull the containers 60 off of the lifting surface 28 and conveyor 76.

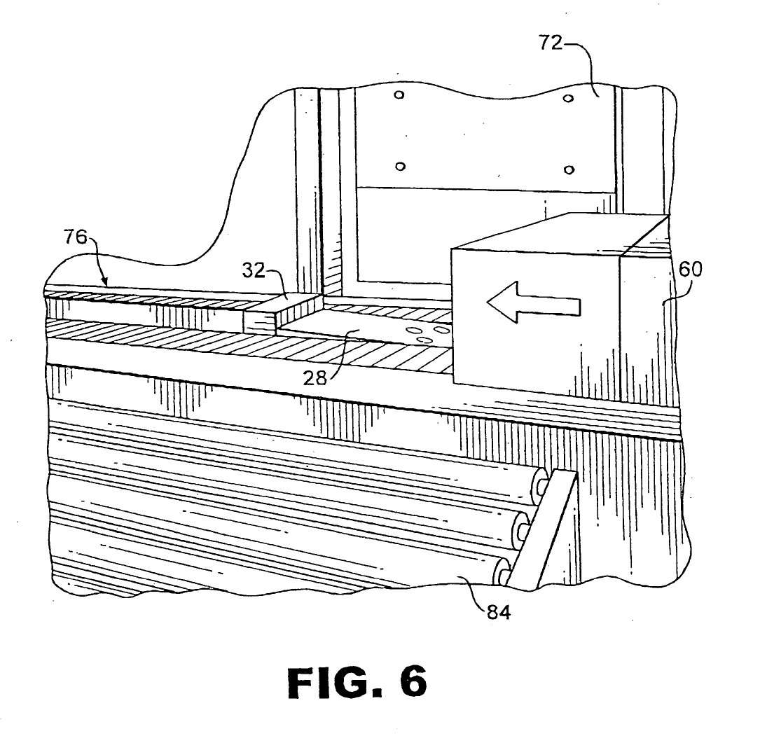

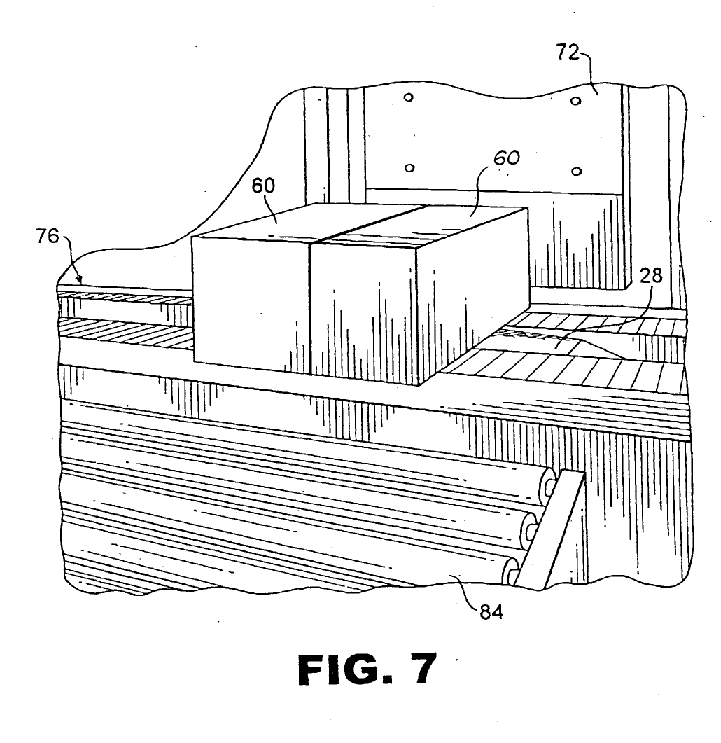

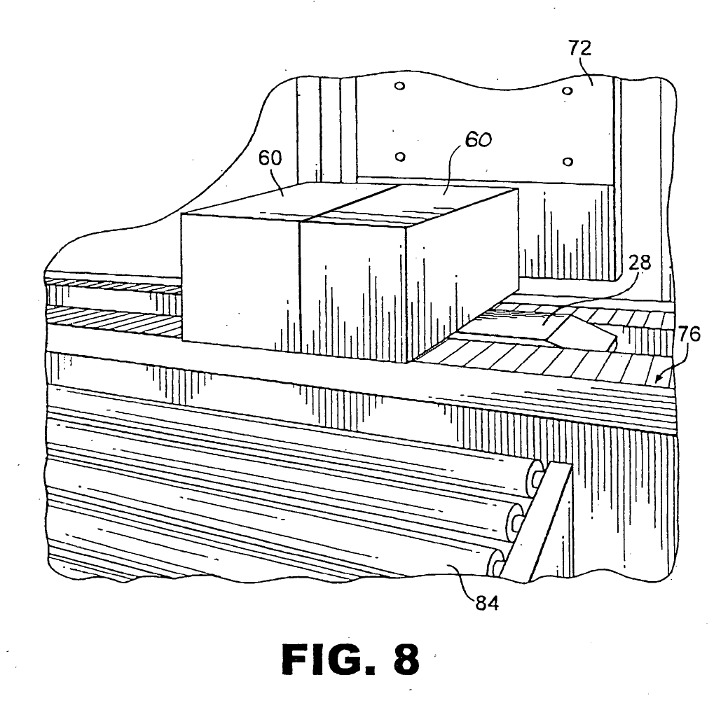

As shown in FIG. 6, the containers 60 are carried by movement of the conveyor 76. The containers 60 contact the inclined lifting surface 28 and travels up the inclined surface through the driving force of the conveyor 76 and the container's own momentum. The pushing apparatus 72 is in a position lateral to the conveyor 76, lifting surface 28, and the containers 60 so as to not interfere with movement of the containers 60. The containers 60 travel up the inclined lifting surface 28 to the point that the containers 60 contact stop 32, whereupon forward movement of the containers 60 is halted, as shown in FIG. 7. Lifting surface 28 is then substantially leveled, as by operation of the solenoid 64, to the position shown in FIG. 8.

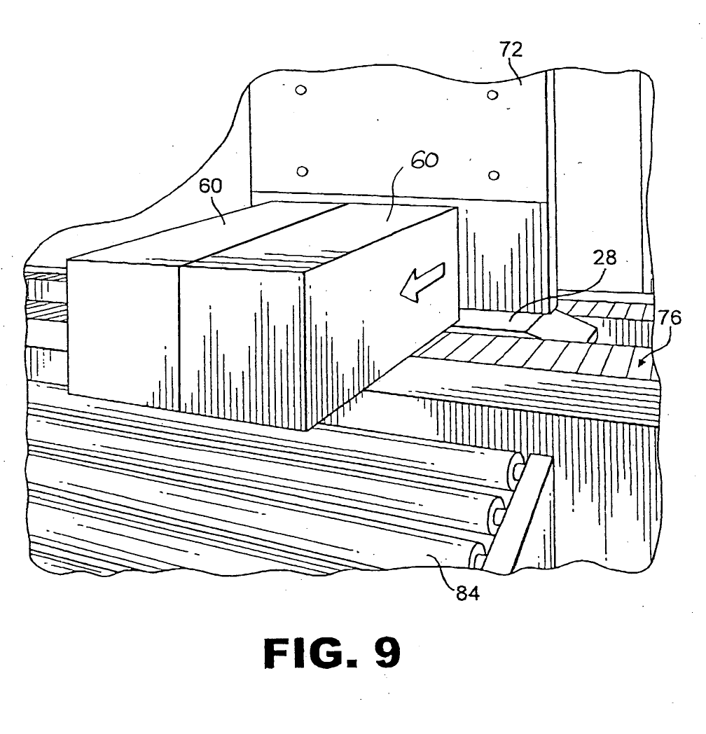

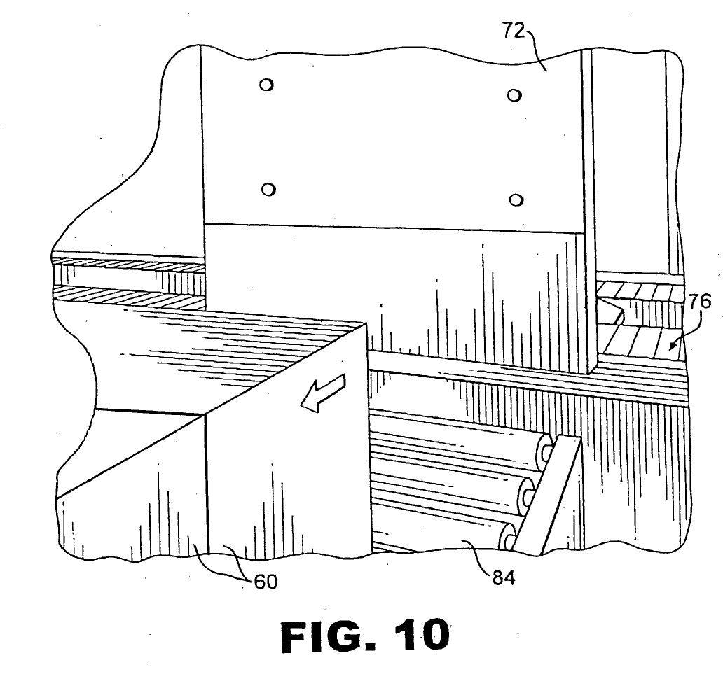

The moving apparatus is then operated to move the push plate 72 across the lifting surface 28 to contact the containers 60 and direct the containers laterally onto conveyor 84 (FIG. 9). The push plate 72 is then on an opposite side of the conveyor 76 from the position where it began (FIG. 10). The push plate 72 can be retained in this position so as to move other containers 60 off of the lifting device 28 in an opposite direction, such as to a storage position that is on the side of the conveyor 76 that is opposite to the conveyor 84. Alternatively, the push plate 72 can be retracted to the original position shown in FIG. 5 to repeat the process.

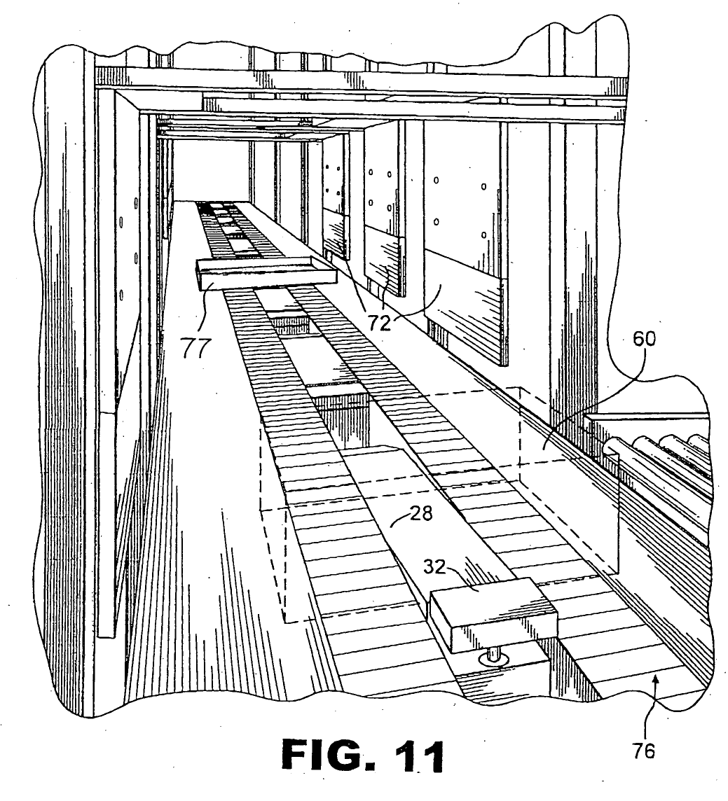

The invention is well-suited for use in warehousing and large scale container storage facilities. As shown in FIG. 11, a single conveyor 76 can service a plurality of container directing apparatus according to the invention. Thus, a series of push plates 72 are located along the path of the conveyor 76 and can direct containers 60 into any necessary container storage position or transfer conveyor.

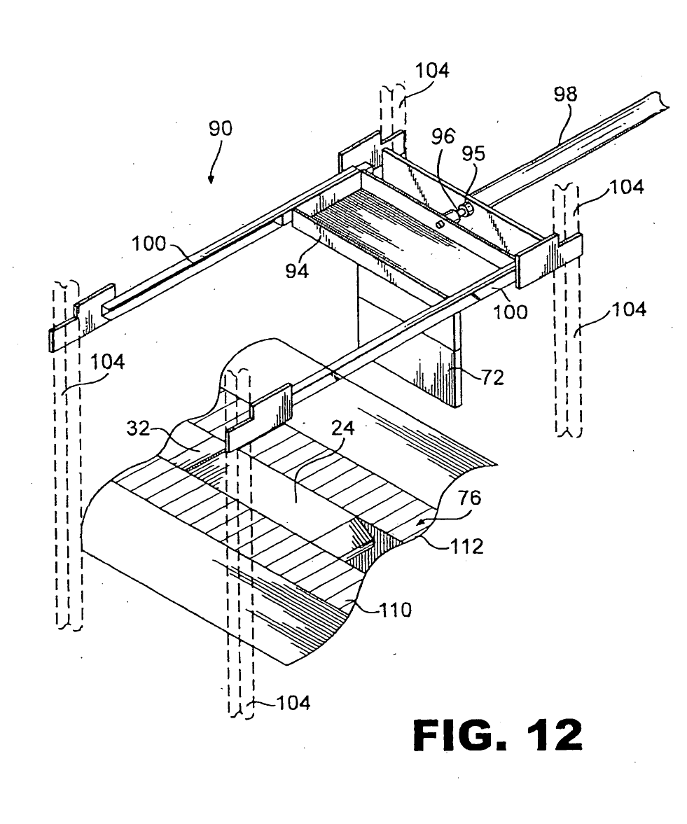

There is shown in FIG. 12 one embodiment of a moving apparatus 90 according to the invention. The pushing apparatus 90 has a push plate 72 or other suitable structure for contacting the container 60 and moving the container off of the lifting surface 28. The push plate 72 can depend from a guide member 94 which is operated by suitable structure such as shaft 96 to move along guide rails 100. Thus, the push plate 72 is configured to contact one or more containers 60 supported from above the containers 60. The shaft 96 is operated through suitable driving structure such as a solenoid, pneumatic or hydraulic drive, or other suitable structure. The guide rails 100 can be supported by connection to suitable supports 104. The shaft 96 can move through a suitable sleeve 98. Alternative structure for moving the push plate 72 or other moving apparatus can be used.

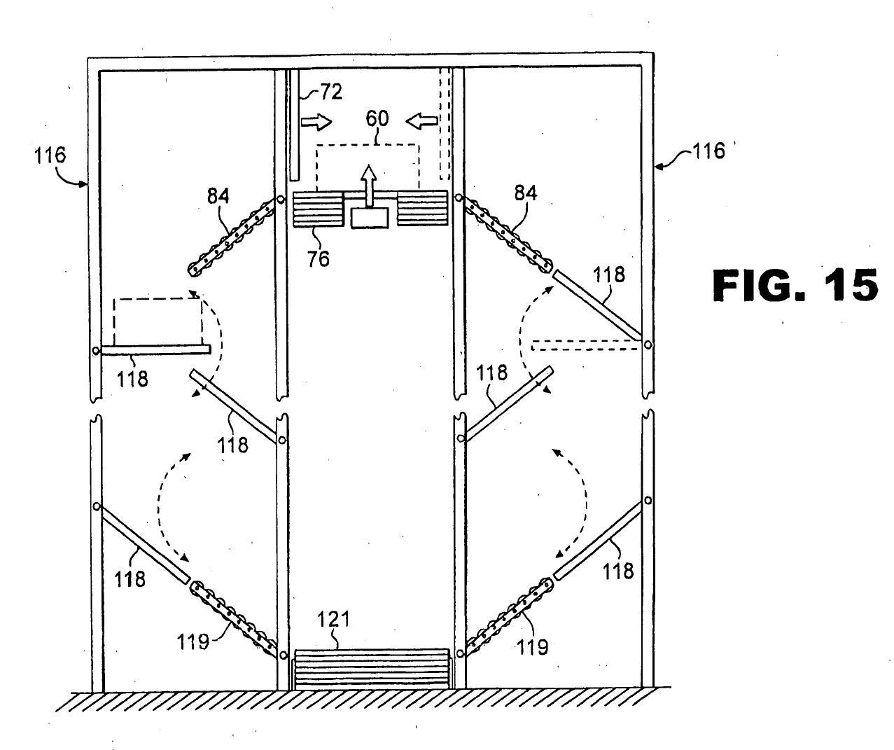

The container directing apparatus of the invention can be used in conjunction with directing containers 60 to other conveyors for transferring the container to any desired location. In one embodiment, however, the conveyor 76 is flanked by a plurality of storage positions and container directing apparatus according to the invention are utilized to direct the containers in any necessary fashion. The storage stations can be of any suitable design. In one embodiment as shown in FIG. 15, the storage stations are vertically accumulating storage stations, such as those shown by Grace, U.S. Pat. No. 4,621,745, the disclosure of which is incorporated fully by reference. Such an individual container storage and delivery system can be provided adjacent to the conveyor 76. The conveyor 76 is preferably at or above the top of the towers. The push plate 72 directs the containers 60 onto conveyor 84, which directs the containers 60 to the top of the towers 116. Alternatively, the containers 60 can be pushed directly into the top of the tower. The tower 116 has a frame that defines first and second tower sections, each supporting a number of vertically spaced shelf trays 118 which in turn support the containers which are stacked on the trays when loaded. The shelf trays 118 of each tower section face inwardly toward and are staggered relative to each other. Each tray is mounted for pivotal movement about a horizontal axis and is operated so that when containers 60 are dispensed from a chute 119 onto a discharge conveyor 121, each higher tray beginning at the bottom and progressing upward one at a time, pivots to transfer its carton to the upwardly tilted, next lower, empty shelf tray. This process is repeated until each container 60 has been transferred to the next lower shelf tray. As a container 60 is loaded at the top of the tower, the shelf trays are operated to pass the container downwardly in a zig-zag fashion from one tray to another until it reaches the highest unloaded shelf tray. The container storage system may be configured to receive a plurality of containers, designate the plurality of containers as a single unit, and output the unit formed from a plurality of containers to the moving apparatus. For example, the container storage system may designate two containers as a single unit when received. The container storage system may discharge two or more containers as a single unit to the moving apparatus to be handled by the container directing apparatus 20. In at least one embodiment, the container storage system may output and receive the same number of items forming a single unit. For instance, if a unit has been designated as being formed from two containers, and the container storage system receives six containers, then the container storage system will have three units to be discharged from the container storage system to the moving apparatus.

The system can be part of an integrated, computer-operated container storage and delivery system in which the computer tracks the position of containers throughout the system and on the conveyor 76. The container directing apparatus according to the invention are utilized to direct the container 60 from the conveyor 76 into the appropriate storage position or transfer conveyor.

The conveyor 76 can be of any suitable design. In the embodiments shown, the conveyor is a chain conveyor having tracks 110, 112 that are spaced apart in substantially parallel relation, as is known in the art. The lifting device 24 is positioned between the tracks 110, 112 so as to lift containers off of the tracks, such that the container can be directed by the push plate 72.

In other embodiments, as shown in FIG. 11, the conveyor 76 may include or more trays 77 configured to carry containers 60 along the conveyor 76. The trays 77 may be engaged by the conveyor with hooks or other conventional systems know in the art. The trays 77 may or may not have sides. The trays 77 may be configured to contain two or more containers.

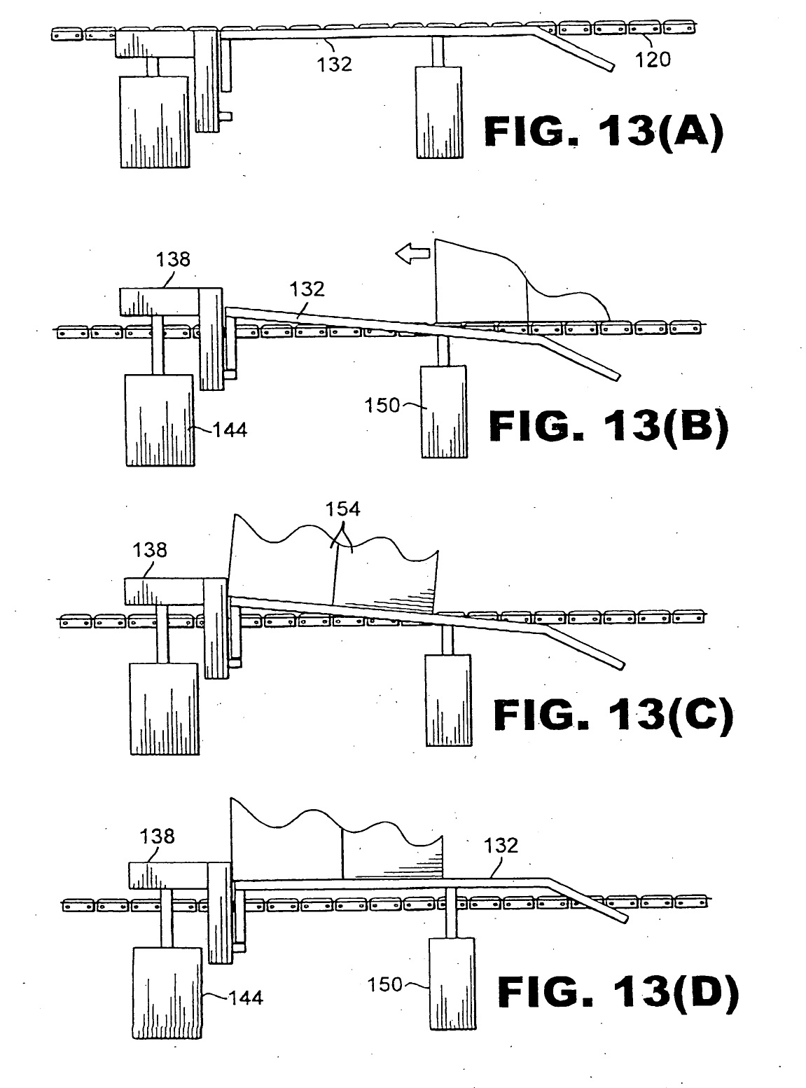

There is shown in FIG. 13 an embodiment of the invention in which conveyor 120 is a chain conveyor. The system can include a pair of spaced apart chain conveyor tracks with a container directing apparatus positioned in part between the chain conveyors. The container directing apparatus can include a lifting device with lifting surface 132, stop 138, actuated by suitable structure such as solenoid 144, and with suitable structure such as solenoid 150 to level the lifting surface 132. The action of the container directing apparatus can be as previously described, or can be alternative apparatus. The container lifting device can accordingly be in an initial position wherein containers being conveyed on conveyor 120 are unimpeded, as shown in FIG. 13A. In FIG. 13B, the lifting surface 132 is inclined and the stop 138 is raised. In FIG. 13C, the containers 154 has contacted the stop 138. In FIG. 13D, the lifting surface 132 has been leveled by operation of the solenoid 150 and the container can be directed to an appropriate location.

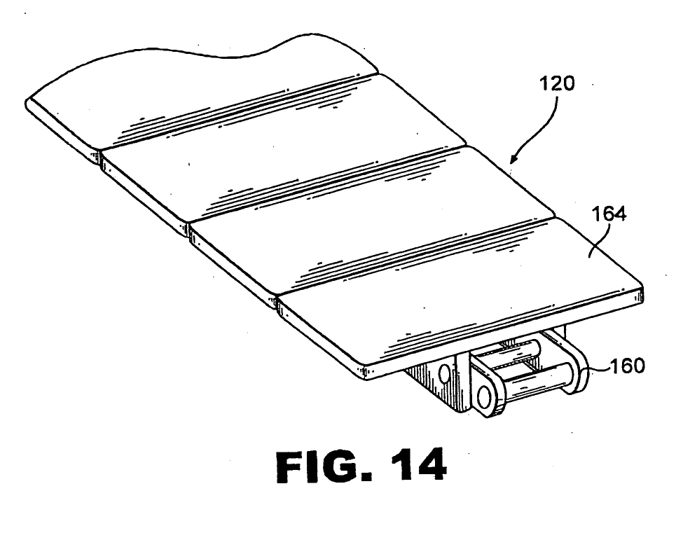

In FIG. 14, there is shown a chain conveyor track useful for the invention. It will be appreciated that the conveyor 120 is only one of two substantially parallel tracks which together comprise the conveyor. Containers are rested across the tracks with opposing edges of the container resting on opposing tracks. The chain conveyor comprises a chain 160 which has connected chain links and is moved in conventional fashion to translate the conveyor and containers. Top plates 164 are attached to the chain 160 by suitable means. The top plates 164 provide a substantially smooth and level surface for the containers. The top plates 164 can be made of durable materials such as plastic or metals, or metal coated with plastic, and also can be padded. Various plate and chain configurations for chain conveyors are known in the art. The dimensions of the chain 160 and top plates 164 can vary according to the size and weight of containers which are to be conveyed. In one embodiment, the chain is ⅝″ and the top plates are approximately 3½″ in width. Other chain conveyor constructions and dimensions are possible.

This invention can be embodied in other forms without departing from the spirit or essential attributes thereof. Many different mechanical systems can be designed to construct container storage and delivery systems according to the invention and, accordingly, reference should be had to the following claims, rather than to the foregoing specification, as indicating the scope of the invention.

1. A container directing apparatus for directing containers carried by a conveyor, comprising:
a lifting device for lifting at least two containers together off of said conveyor; and
a moving apparatus for moving that at least two containers off of said lifting device.

2. The container directing apparatus of claim 1, wherein the conveyor comprises a tray configured to hold at least one container.

3. The container directing apparatus of claim 1, wherein said conveyor moves in a direction of travel and said lifting device comprises a lifting surface, said lifting device inclining said lifting surface upward in said direction of travel.

4. The container directing apparatus of claim 3, wherein said lifting device, after inclining said lifting surface, substantially levels said lifting surface.

5. The container directing apparatus of claim 4, wherein said lifting device comprises a stop for stopping the movement of said containers on said lifting surface.

6. The container directing apparatus of claim 4, wherein said stop is operatively connected to said lifting surface, whereby lifting of said stop will incline said lifting surface.

7. The container directing apparatus of claim 4, wherein said moving apparatus directs containers off of said lifting surface when said lifting surface is substantially level.

8. The container directing apparatus of claim 4, wherein said lifting device comprises at least one solenoid for inclining said lifting surface and for substantially leveling said lifting surface.

9. The container directing apparatus of claim 1, wherein said conveyor comprises first and second substantially parallel conveyor tracks, and said lifting surface is dimensioned to fit between said tracks.

10. The container directing apparatus of claim 1, wherein said moving apparatus comprises a push plate and means for moving said push plate over said lifting device, wherein said push plate will contact said containers and move said containers off of said lifting device.

11. The container directing apparatus of claim 10, wherein the push plate is configured to contact one or more containers and be supported from above the container.

12. The container directing apparatus of claim 10, wherein said moving apparatus is capable of directing containers of said lifting surface in at least two directions.

13. The container directing apparatus of claim 10, wherein said push plate forming said moving apparatus is configured to engage and push at least two containers together.

14. The container directing apparatus of claim 11, further comprising at least one container storage station.

15. The system of claim 14, wherein said container storage station comprises a vertically accumulating storage and delivery apparatus.

16. The system of claim 14, wherein the container storage system is configured to receive a plurality of containers, designate the plurality of containers as a single unit, and output the unit formed from a plurality of containers to the moving apparatus.

17. A method of storing and delivering containers, comprising the steps of:
conveying at least two containers on at least one conveyor having spaced apart conveyor tracks;
directing said at least two containers from said conveyor by lifting said at least two containers off of said conveyor tracks with a lifting device and moving said containers off of said lifting device with a moving apparatus.

18. The method of claim 17, wherein said lifting step comprises providing a lifting surface, and inclining said lifting surface upward in the direction of conveyor travel such that containers move upward on said lifting surface.

19. The method of claim 18, further comprising the step of leveling said lifting surface after said containers have moved onto said lifting surface, said moving step being performed after said lifting surface has been substantially leveled.

20. The method of claim 17, wherein said at least two containers are directed into a container storage and delivery apparatus.
